(19) United States
(12) Patent Application Publication
(10) Pub. No.: US 2007/0078697 A1
(43) Pub. Date: Apr. 5, 2007

(54) Client appointment scheduling method, system, and computer program product for sales call, service scheduling and customer satisfaction analysis

(76) Inventor: Gary S. Nixon, Pleasanton, CA (US)

Correspondence Address: GERALD L. ROBERTSON, ESQ., 1110 CASTLE OAKS DR., NAPA, CA, 94558, US

(21) Appl. No.: 11/244,952

(22) Filed: Oct. 5, 2005

(51) Int. Cl. G06F 9/46

(52) U.S. Cl. 705/9

(57) ABSTRACT

A system, method and computer product for use in scheduling sales and service activities between service providers and customers, allowing for transfer of information between service providers and customers via phone, mail, e-mail, text messaging or web-based information transfer according to customer preferences and further allowing the service provider to maintain transaction, contact and customer satisfaction data for reporting and analysis by augmenting traditional databases with self-generated data and tracking customer spending and satisfaction results.

### FIELD OF THE INVENTION

The present invention relates generally to appointment scheduling applications and more particularly to systems for the remote scheduling and monitoring of appointments including analysis of appointment results and customer satisfaction.

### STATEMENT OF GOVERNMENTAL ASSISTANCE

Applicant hereby represents that no part of the subject invention or application has come about with the assistance of government funds or by virtue of a government program.

### BACKGROUND OF THE INVENTION

One co-inventor, Canaday, R., of the instant application previously filed application Ser. No. 09/541,382 for a Method, System and Computer Program Product for Remote Service Scheduling, which application went abandoned in 2002.

For service providers who provide services to consumers or other clients, scheduling of appointments can be burdensome both from a time and labor standpoint. In today's fast-moving economy, more and more pressure is felt by both clients and service providers to improve productivity. Given the evolution of high technology tools, service providers and clients generally try to squeeze more work, appointments and hence, results out of each day. On the service provider side, the object is to maximize the number of appointments per employee or day, and for the client, to obtain more results or accomplish more tasks. Commensurate with these pressures is the need for flexibility in the scheduling of appointments—specifically the need for flexibility for re-scheduling, cancelling and otherwise managing appointments. Furthermore, with the advent of multiple means of communication; e.g., internet or web-based, e-mail, land line or cell phone, facsimile transmission and of course, conventional mail, more avenues of communication are available to assist service providers and clients in meeting their goals. However, because of these multiple means of communication, managing customer service and contact has become far more complex, particularly where automation or computer assistance is employed.

Historically, many of the commonly used scheduling applications lacked control. Such applications did not distinguish between client and service provider, and in some cases simply provide a stand-alone computer solution to managing either a service provider's or a client's schedule, or the equivalent with a web-based system. In both situations, security has been traditionally weak; for web-based applications, giving little security for clients to schedule their own appointments, making establishing appointments somewhat random or unstructured, with such problems being exacerbated in situations where a client wishes to cancel or reschedule an appointment.

For applications which schedule meetings, not simply appointments, the solution is more complex. In such situations, the application must require activity from all participants in order to achieve a mutually acceptable appointment. When applied in the service provider setting, the same security issues are present in such applications, and if uncontrolled; i.e., allows all prospective clients to schedule their own appointments for services, would leave the service provider with no effective means to control such scheduling, creating chaos in the workplace.

As the evolution of personal and web-based organizers has evolved, some aspects of the control of scheduling have been attempted. In some cases, web-based applications have allowed service providers to provide clients with a choice of appointment dates and times to select, allowing some control of the flow of clients at the provider's place of business. Further, information from the web-based application has been supplemented by confirmation means, typically a computer generated post card reminder or confirmation, or a human-generated or computer-generated phone call to the client reminding the client of his or her appointment.

More recently, in the case of a phone based confirmation to the client, clients have been offered the choice of either cancelling or rescheduling their appointment. It is here that most of the technology and prior art has reached a plateau.

Important to the service provider is the means to use multiple lines of communication for the establishing, reminding, confirming, cancelling and rescheduling of appointments. Moreover, the need to obtain feedback regarding the scheduling application is imperative to identify flaws in the system, analyze cancellation rates, calculate numbers of“no-show” etc., to assist the service provider in scheduling his own work hours and staff requirements and further planning future marketing or sales activities.

For the service provider who maintains a detailed database of information on each client, such databases have largely been wanting for feedback as to appointments and have focused primarily on simply adding data about the service appointment, what was done, when it was done, and in some cases, a related link to the work order or its dollar amount. In such cases, little, if any, information is identified about the client's preferences for scheduling, means of communication interface or other satisfaction feedback.

The service provider's database in such instances is largely untapped or even non-utilized as a source of potential demographic information regarding the provider's clients, and is underutilized in terms of providing capability to track the provider's customer satisfaction results or to track the financial performance of his or her business or employees and the value of individual customers.

What is needed is a scheduling, confirmation and analysis tool which not only manages the service provider's clients' appointments, but allows flexibility in that control, with the further capability of monitoring the service provider's performance against client expectations, and provides financial results to the business to assist the service provider in establishing the success of his marketing or sales campaigns and individually, his or her employees.

### SUMMARY OF THE INVENTION

The instant invention can be applied to many kinds of service providers. One application in particular showcases the features and function of the invention; that application is tailored to the automotive dealership, most particularly, its service business. One aspect of the present invention is the ability of the application to automatically interact with a dealer's customers. The interaction includes the following steps. The system queries an auto dealership's management information system or DMS to learn which client (alternately, “customer”) had appointments, is due for service, had looked at cars or spoken with a sales representative. Necessary to achieve this is an Overall Data Management System or “ODMS” Once data is recognized and received into the ODMS, a reminder subsystem may utilize the data in the ODMS to contact the customer via telephone, email or text message to remind the customer of the appointment or to follow up on a visit to the dealership.

It is an object of the current invention to provide input from the customer to choose the manner in which the customer will be contacted either as a follow-up to the customer's visit to the dealer's showroom or to confirm or reschedule a service appointment. DMS's traditionally have not tracked discrete customer preference information in this manner.

Another aspect of the invention provides that during a phone call, the system determines whether the phone is answered by a person or an answering machine. If a person answers, then a message is transmitted that allows that person to either reschedule or accept the appointment. If an answering machine is detected, the system plays a different message instructing the customer to call a special telephone number to change the appointment. The system also generates a report which tracks how many customers were contacted, how many customers accepted the appointment an how many customers changed their appointments.

In the case of contact by email, the system allows the customer the option to simply accept the appointment or click on a link to reschedule. Additionally, preferably 2 or 3 days after the transaction with the auto dealership (either sales or service) a short email is generated and sent to the customer to solicit the customer's evaluation of his or her satisfaction with the dealership's performance. Responses from all customers queried are accumulated daily and sent to dealership management so that any complaints can responded to with immediacy and be quickly resolved.

The system's reminder function may be used pro-actively to contact customers with special offers or sales campaigns such as various routine maintenance activities, new car promotions, moving notices and the like. In doing so, the system queries the DMS to identify specific customers targeted for the program such as the time since the customer's last oil change or the impending expiration of the manufacturer's warranty, and then contacts the targeted customers with an appropriate message directly related to their situation or potential interest.

It is a further object of the present invention to enable the service provider to track customer transactions from initial contact through the completed transaction to their response to a customer satisfaction survey.

Again in the auto dealership embodiment, as an example, one reminder is sent to previous customers that have not been into the dealership in 12 to 18 months. The system checks the DMS daily to track customers having visited the dealership. The system matches the individual contacted to his or her visit to the dealership and tracks the amount of money the customer spent purchasing a car or having it serviced as a result of that contact. For customers preferring email contacts the system sends the customer a survey designed by the dealer to determine the customer's satisfaction with their experience. The system tracks the financial results, the number of contacts having generated revenues and allows management to evaluate the performance of its various sales campaigns.

Additionally, the system permits the dealership to identify each sales order and service order for a pre-selected time period and relates the order with the individual sales person or service advisor who was involved, enabling a quick indication of employee productivity and any customer rating that individual earned executing the service or sales transaction.

Referring again to the embodiment for auto dealers, many auto dealerships are part of multi-dealership or multi-brand groups. Furthermore, in many cases, dealerships in a single group will operate on different DMS platforms. To date, the most employed systems are provided approximately 80% of the time by either ADP or Reynolds & Reynolds. It so happens that data from these two platforms are not easily combined for an aggregate view of the effectiveness of marketing programs across an entire group. It is an aspect of the present invention to aggregate data from multiple DMS platforms and combine the data so that executives responsible for groups of dealerships can view performance of their marketing and sales programs system-wide, regionally, by individual store, or even with the same level of detail as the local dealership manager.

It is an objective of the present invention to aggregate and augment current DMS systems to allow service providers to chart customer purchase history by zipcode.

It is a further objective of the present invention to organize and tier customer data by value or some other indication of customer satisfaction.

It is yet another objective of the present invention to track customer communications, obtain useful data therefrom to analyze such communications in terms of their effectiveness.

It is a further objective of the present invention to track customer satisfaction scores.

It is yet another objective of the present invention to obtain detailed information related to customer transactions thereby allowing analysis related to employee productivity and customer satisfaction with specific employees.

A further objective of the present invention is to identify potential sales opportunities as well as to identify where opportunities were lost in order to continue to follow up with a customer, or to anticipate future reminder needs.

### BRIEF DESCRIPTION OF THE DRAWINGS

FIG. 1 is a process flow diagram showing the overall data management system or ODMS;

FIG. 2 is a process flow diagram showing the import system which obtains data for the ODMS from either the two major DMS platforms or from a third party database.

FIG. 3 is a process flow diagram showing the reminder system which uses the data obtained by the ODMS to schedule appointments, reminders, etc.

FIG. 4 is a process flow diagram showing the flow of customer satisfaction and other transaction related information for reporting and analysis.

FIG. 5 is a typical output screen showing the reporting of . . .

FIG. 6 is a typical output screen showing the reporting of . . .

FIG. 7 is a typical output screen showing the reporting of . . .

FIG. 8 . . .

### DETAILED DESCRIPTION OF THE INVENTION

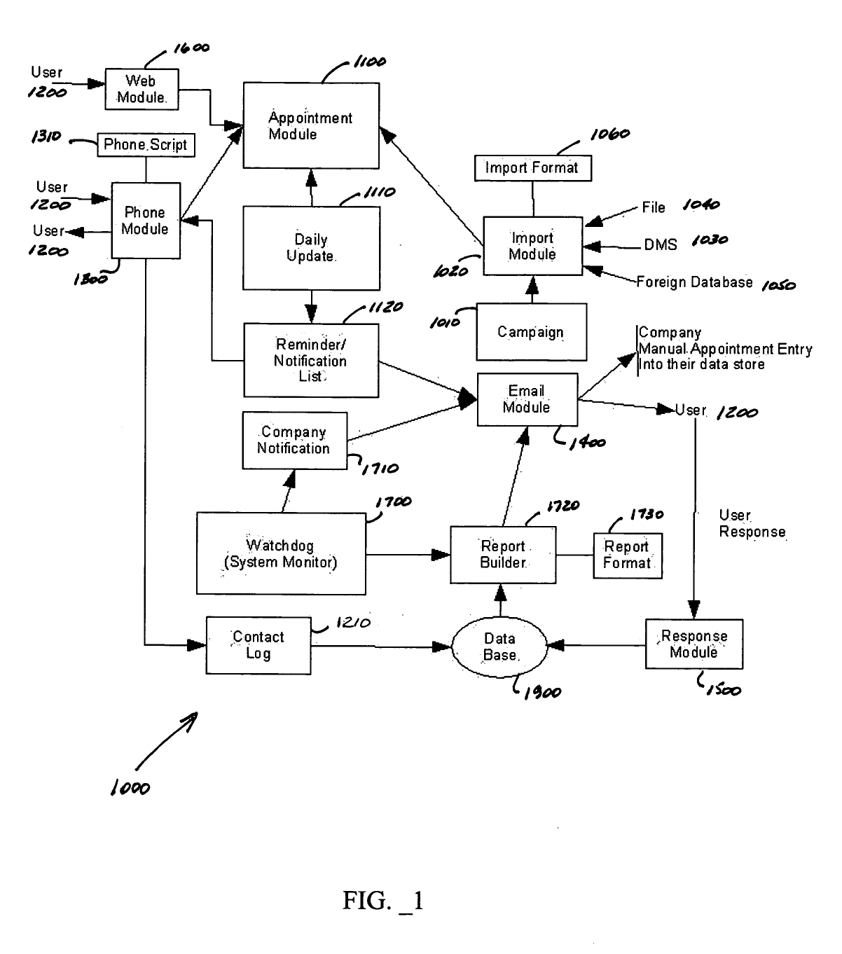

Referring to FIG. 1, in the present system 1000, there are three basic process flows: imported data flow, user-inputted data flow, and system monitoring or “Watchdog” triggered data flow.

Turning first to imported data flow, campaign 1010 triggers the import of data, providing appropriate data source and script. A campaign is a business function performed on behalf of the service provider, in the case of the preferred embodiment, an auto dealer. Campaign 1010 comprises among other functions importing data into the ODMS and sending reminders to customers. Campaign 1010 controls many aspects of the system, including scheduling for imports, data source and script for imports, when phone calls and emails are created and made or sent, script control parameters for phone calls, and control over the handling of data generated through the import and other processes for that specific campaign.

Import module 1020 connects to data sources such as a DMS 1030, an external file 1040, or a foreign database 1050 for the purpose of obtaining the raw data for campaign 1010 to use and control. Import module 1020, directed by import format 1060, downloads the information into an appointment module 1100. This information is used to create new appointments and notifications, and create or update users. Appointment module 1100 is central to system 1000, providing the data source or operational commands for the majority of the uses of the system.

The import process is fully scripted, including the flow for connecting to and retrieving data and the data map between the external data source and the system. This data may be single-use, recurring appointments or notifications, and links together user 1200, campaign 1010, and other pertinent system data such as the provider for the appointment and the service being provided. Daily update 1110 runs and builds reminder/notification list 1120 interfacing with the list as well as appointment module 1100. Daily update 1110 builds the reminders and notifications that should go out each day thereby establishing list 1120. This process is guided by campaign 1010, determining when to build the reminders and notifications, and governing some of the content. Daily update 1110 also executes data cleanup tasks governed by campaign 1010 through which the data was created, and generates summary reports of system use for internal monitoring and maintenance purposes.

As seen further in FIG. 1, a phone module 1300 picks up the list of phone calls to be made, guided by settings in campaign 1010 for which reminder/notification list 1120 was built. Phone module 1120 makes the calls, and logs the results through a contact log 1210. Phone Module 1300 governs all aspects of phone calls, both inbound (to make appointments) and outbound (to send reminders and notifications). The flow of control for the phone calls is governed by a phone script 1310, which may be customized according to the dealer's or service provider's pre-selected criteria. On outbound phone calls, phone module 1300 determines the appropriate phone number to use (based on campaign 1010 criteria, user preference, and appointment/notification settings). Phone module 1300 determines proper content (such as language to use) through user preferences and script parameters set through campaign 1010, and the appropriate provider and service for each message sent.

Phone module 1300 logs all outbound communications through contact log 1210. Contact log 1210 contains information on every call made and every email, text message, or piece of mail sent through the system, including time, results, campaign, user, and message information.

As further shown in FIG. 1, where a customer or user, 1200 has indicated a preference to be contacted by email, email module 1400 controls emails that are sent to users. Email module 1400 receives from list 1120 the emails to be made, guided by settings in Campaign 1010 for each reminder or notification, and sends the emails. Email templates are used which support multiple languages, media links, surveys and processes, allowing the recipient to respond to the email. The most typical responses include cancelling or rescheduling an appointment.

When and if user 1200 responds to the email, a response module 1500 logs the response. The response can be in the form of a survey response or a request for cancellation or rescheduling. Response module 1500 handles survey and other responses from emails, collecting the information and continually updating the survey response data. Additionally, web module 1600 may be the source of user input as provisions for information input is found on the dealer's website, allowing information to flow into system 1000. Web module 1600 allows users to make and review both appointment and personal preference information. User 1200 may enter the system through a login process, or through a response to an email which identifies the user to the system. Web module 1600 allows comprehensive use preference and information access, allowing user 1200 to update personal information and indicate how he or she wishes to be contacted.

In the case of event-triggered data flow, Campaign 1010 is not the source of data which provides input to appointment module 1100.

Therefore, it can be seen from FIG. 1 that information or data can be provided to appointment module 1100 by means of either import module 1020, phone module 1300 or web module 1600. Other information can be provided to appointment module 1100 as well.

System monitor or “watchdog” 1700 takes the appointment, user, and contact information and build reports and emails through report builder 1710 for the employees of the company for which the system is dedicated. As a result of watchdog 1700 process reviews, new appointments and users 1200 are created in the system through the other input modules such as phone module 1300 and web module 1600 and builds emails containing the information to be handled by company notification system 1720.

System monitor 1700 or watchdog watches the function of the system, ensuring that all processes are running appropriately and monitoring system heartbeats for continued function. System monitor 1700 has a multi-level warning system, including the ability to send emails, restart the system, and reboot a server automatically as issues are escalated. The system monitor is a comprehensive monitoring and scheduling mechanism that supports process plug-in (through a simple API). Two such processes are the company notification process 1710 and report builder process 1720.

Company notification system 1710 sends messages through email module 1400 to the appropriate recipients at the company or service provider 1800.

A recipient at company 1800 reviews the information, resolving duplicate user information, if any, and entering the information into their data source.

Report builder 1720 queries user, appointment, contact, and other data and builds reports containing summary and other pertinent information. This information is generally provided to report builder 1720 by information flowing by way of system monitor 1700, or by way of response module 1500 and contact log 1320 each comprising inputs to data base 1900. Report builder 1720 generates reports based on scripted report templates provided by a report format 1730, and sends them to the appropriate recipients at company 1800. These reports include contact summaries, appointment and notification summaries, and other information regarding new and changed appointments and user/client information.

In this way, the system can source known information, accept information as a result of query or response, establish, monitor and change schedules, all done using customer preference and in accordance with established campaigns designed to service a customer and meet the service provider's business goals.

In FIG. 2, reminder subsystem 2000 is detailed in terms of process and flow. The basic function of reminder subsystem 2000 is to allow system 1000 to send reminders to users via telephone, email, text messaging, and regular U.S. Mail.

As in the case of the import subsystem as expressed in FIG. 2, campaign 2010 governs how reminders are built and sent. The only data that is permitted to override campaign 2010 settings are the client preferences and available Client data. Campaign 2010 indicates when and if to send reminders, how they should be sent, and the type of reminder to send. As described above in the description of FIG. 1, campaign 2010 (identical to campaign 2010 in FIG. 2) populates the reminder list 2120 and provides configuration/control information for phone module 1300.

Referring again to FIG. 2, an appointment 2100 is created via the import process or through conflict resolver 2040. Appointment 2100 links one customer (not shown), one aspect (not shown), one provider 2012, one service 2014 and campaign 2010 to provide information about a scheduled appointment for a customer. Campaign 2010 indicates when reminders should be sent, acting as a filter for adding existing appointments 2100 to reminder list 2120. Only one reminder is sent to the customer via the customer's contact information for each appointment per campaign.

Daily update 2110 re-creates reminder list 2120 at regularly scheduled intervals every day.

Phone module 2300 controls which phone calls to place based on the contents of the reminder list 2120. If associated campaign 2010 indicates that a call can be made, phone module finds a free phone line, loads the appropriate phone script 2310, determines if phone reminders are enabled by service 2014 associated with the reminder, and makes the call using the phone script 2310.

A phone call is a concatenation of recordings 2320 appropriate to provider 2012, service 2014 and campaign 2010, guided by user interaction with phone script 2310 via their telephone.

Phone script 2310 governs the flow of recordings 2320 presented to a user on a telephone. The flow is guided by choices made at appropriate times by the user. Script 2310 contains special tagged items that indicate campaign-specific custom recordings, a custom 2330 to use in lieu of a standard recording 2340. For example, campaign 2010 may be tailored for a specific provider 2012, with provider-specific recordings used for the greeting presented to the user. Script 2310 “asks” campaign 2010 for the appropriate tag value, and loads the indicated recording.

Recordings 2320 are files containing fragments of sound to play for users based on the flow indicated in a Script 2310. There are three types of recordings: custom recording 2330, standard recording 2340, and built-in recording 2350. Built in recordings 2350 contain sounds that are used by phone module 2300 directly, such as numbers, “AM/PM”, and other sounds that are common across all scripts and campaigns. Standard recordings 2340 are sounds that are referenced in Script 2310, but not customized for any dealer. Custom recordings 2330 contain all sounds referenced by script 2310 or phone module 2300 that are specific to the Dealer. Phone module 2300 looks first in the custom recordings 2330 for the file it needs. If it does not exist there, phone module 2300 then looks at standard recordings 2340. If it is still not found, phone module 2300 loads the file from basic recordings 2350. All custom recordings 2330 must be named appropriately for each script 2310. Even built-in recordings 2350 may be tailored for a script or campaign, and will override the normal sounds used by phone module 2300 if the appropriate file exists in custom recordings 2330.

For reminder system 2000, provider 2012 has properties which affect the way reminders are sent. For all reminders, provider 2012 determines if a reminder is sent or not. In the case of phone calls, for example, provider 2012 indicates whether the prerecorded name of provider is to be played for the Client. For emails, provider 2010 has properties governing what is included in the email reminders.

Referring still to FIG. 2, similar to providers 2012, service 2014 has properties governing when reminders are generated (immediate, normal, or none). In the case of email reminders service 2014 determines via email module 2400 and its associated email templates 2410, which template to use. In the case of phone call reminders, service 2014 checks to see if a prerecorded service name that should be played for the customer.

Just as in FIG. 1, as shown in FIG. 2, email module 2400 is responsible for sending email reminders to customers. Email module 2400 checks reminder list 2120 for reminders that are to be sent as emails and prepares and sends the email to the customer's email address. Email module utilizes email template 2410 to determine the content of the email. Email module must have access to an SMTP server that is an appropriate source of emails for the service provider or dealer.

Short messages, or SMS (not shown), behave identically to emails except that the SMS templates allows only plain-text characters and limits the length of the message to 160 characters. SMS is used to communicate with message systems used by cell phones. It utilizes a special email address which forwards the message to the customer's cell phone.

A termplate from email template 2410 contains the structure for the content of an email for sending to a recipient. Service 2014 for which the reminder is being sent determines which email template to use. Email template 2410 may contain a survey 2420 or questionnaire for the customer's input.

An SMS template (not shown) is used by an SMS module to determine the contents for short messages sent to cell phones. The SMS template is limited to no more than 160 plain-text characters, as appropriate for displaying on cell phones.

Survey 2420 contains a set of questions used to elicit information from a customer. The answers to a survey 2420 are sent via SSL to the Dealer's system 1000 server. The structure of a survey is governed by a survey template 2430, which is part of email template 2410 associated with service 2014 for which the reminder is sent.

Referring still to FIG. 2, survey template 2430 dDetermines the contents of survey 2420. Responses to survey 2420 generate a survey result 2440. Each survey 2410 must have a an associated survey template 2430 and corresponding report template (not shown) for summarizing survey results 2440.

Survey results 2440 are the answers to survey 2420 sent out to customers via email. Report Builder (not shown) summarize and report each survey result 2440.

A USPS module 2500 is responsible for generating letters to be sent to customers via the US Postal Service. USPS module 2500 utilizes USPS Template 2510 to perform a “mail merge” and produce letters containing information specific to each customer in reminder list 2120. USPS module 2500 looks at reminder list 2120 and pulls out all reminders that are slotted for USPS delivery. USPS module 2500 must be triggered manually, since it requires a properly set up printer to perform its function.

A USPS template 2510 is a “mail merge” template, merging information from the ODMS for the customer and appointment 2012. USPS template 2510 is discrete for each dealer; the designer of USPS template 2510 must consider such things as letterhead, name formatting, and signature.

An AAGUI 2600 provides configuration options for providers 2012, services 2014, campaigns 2010, appointments 2100 and customers. AAGUI 2600 also provides the trigger for USPS module 2500 and for maintaining system 1000. AAGUI 2600 may also be browser based in character.

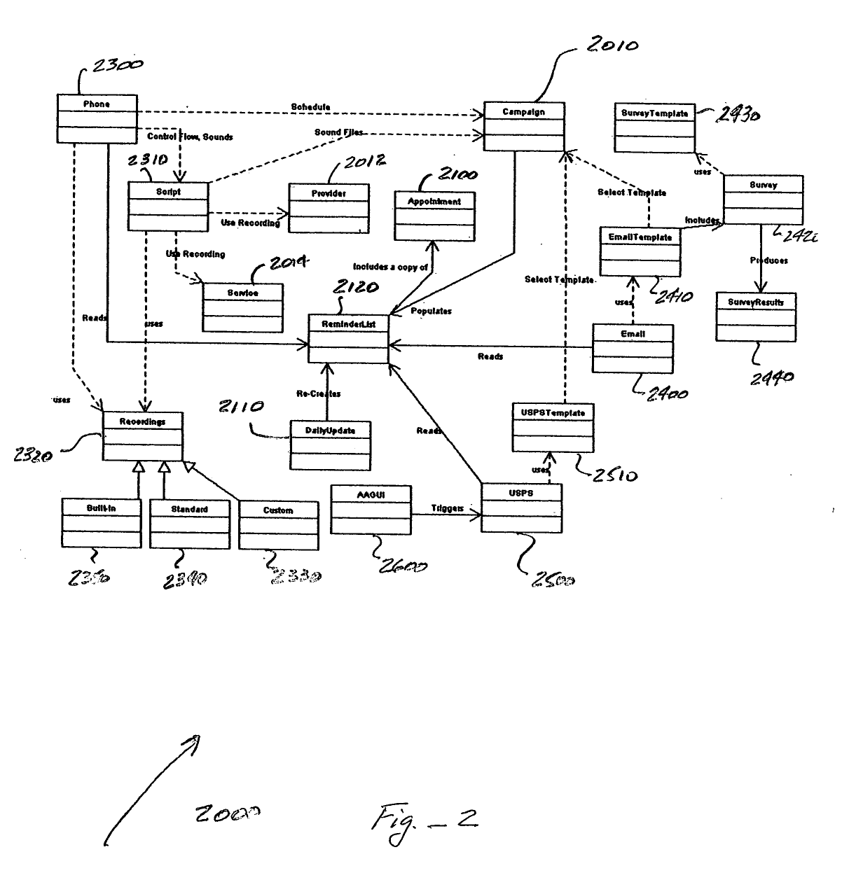

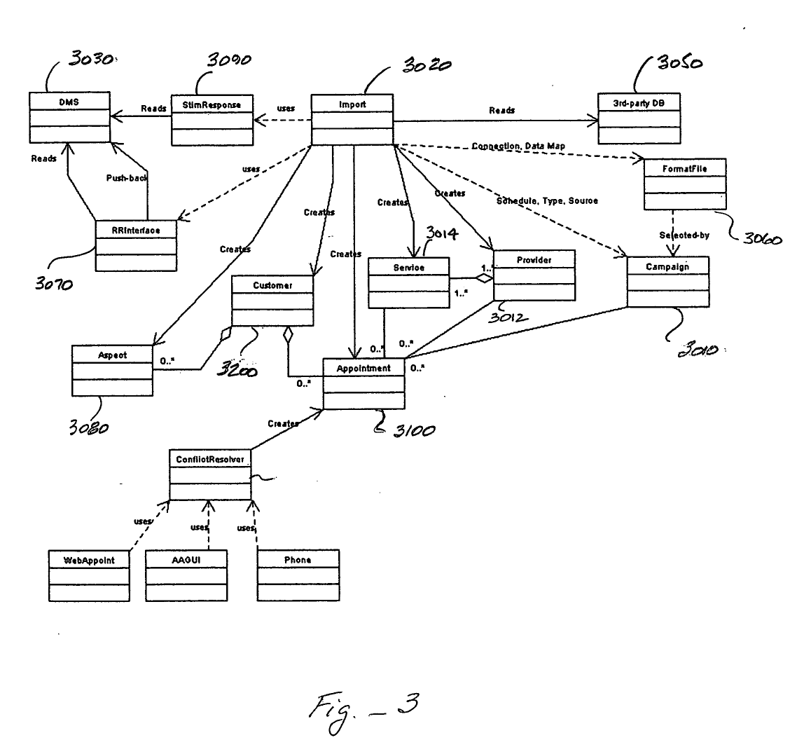

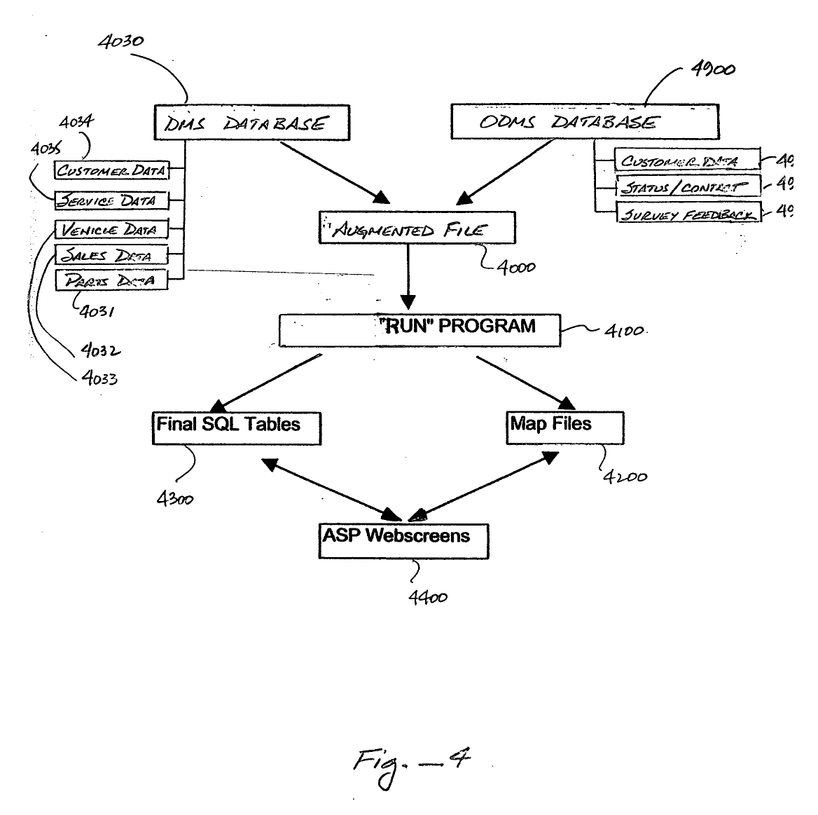

FIG. 3 depicts in further detail the function of import module depicted in FIG. 1. As described above, campaign 3010 dictates or controls the major function of the system. Import module 3020 can receive data or information from several sources. This data source may be a DMS file 3030, a file (not shown), or a third party database 3050. In all cases a format file 3060 dictates the data map between external data sources 3030 or 3050, or and import module 3020. DMS file 3030 is imported through RRInterface 3070 using format file 3060, which supplies the connection, login, session and report information. Format file 3060 also contains the data mapping parameters and data map from DMS file 3030 to input module 3020.

Campaign 3010 tells import module 3020 when to begin. Campaign 3010 passes configuration information to import module 3020, including which format file in format file 3060 to use and what file to use for the results from DMS 3030.

Import module 3020 then launches RRInterface 3070, supplying the appropriate parameters (including FormatFile and output file name). RRInterface 3070 pulls connection and session login information from format file 3060 and connects to DMS file 3030. RRInterface 3070 then pulls the data needed to run a report on DMS file 3030 from format file 3060, and runs a request for the report. As DMS file 3030 responds to the requests made using format file 3060 data, RRInterface 3070 saves raw responses as a report file (not shown). RRInterface 3070 takes this raw response data and creates an output file containing formatted results from DMS 3070. Import module 3020 then loads the output file, reads the parameters that control data parsing from the format file 3060, and uses the data map from the format file to update the ODMS. Import module 3020 can create users or customers 3200, aspects 3080, services 3014, providers 3012, and appointments 3100 in the ODMS. Import module 3020 can also update existing customers, aspects 3080 and appointments 3100.

In the present invention, there are two ways to use files for imports. The first method involves utilizing a file which is read on a fixed schedule and imported into the system. The second method uses “StimRespones” 3090 to trigger imports on the appearance of a file.

The procedure includes campaign 3010 instructing import module 3020 to begin the importbased on its configured schedule. Campaign 3010 indicates the data file to use and format file 3060 containing the parsing and data map information. Import module 3020 verifies the existence of the data file and if the file exists, import module 3020 loads the parsing parameters and data map from format file 3060. Import module 3020 then loads the file, parses the data into information that ODMS understands and updates the ODMS accordingly.

In the case of StimResponse, the process is once again very similar to that described immediately preceding with the exception that the data source is not (necessarily) DMS file 3030. The steps for importing through StimRespones 3090 include drawing data directly from the external database, mapped and used to update the ODMS database directly. No intermediate file is used. Campaign 3010 provides a UDL for connecting to the external database. Format file 3060 provides the data mapping between third party database 3050 and the ODMS. Campaign 3010 provides schedule, data filter, and import type configuration information in addition to the UDL.

In FIG. 4, the process enabling analysis of customer spending, satisfaction and dealer productivity is shown. The present invention provides for creating an augmented file 4000 which compares and combines data from DMS database 4030 and ODMS database 4900. At the very least, DMS database 4030 includes parts data 4031, sales data 4032, vehicle data 4033, customer data 4034, and service data 4035. ODMS database 4900 primarily comprises customer data 4901, contact and status information 4902 of the customer and his transaction, and if available, survey feedback 2903. The combination of these two databases allows a “run” program 4100 to operate on said file to generate final SQL tables 4300 and map files 4200. ASP webscreens select information from map files 4200 and final SQL tables 4300 in order to report and display statistice which are derived from augmented file 4000. The result contains detailed information about dealership customers that have been contacted and their interactions with the dealership. Each day system 1000 (see FIG. 1) downloads information from ODMS Database including: customer contact information, type of contact made (phone, email, text messages), contact status (completed, failed, etc.) and any survey feedback, all by individual customer. The system then downloads information from the dealership's DMS database 4030 into augmented file 4000 that includes: customer contact information, service data, vehicle data, sales data, and parts data, all by individual customer. Run program 4100 then integrates both sets of data and creates final SQL tables of all information collected from the DMS for every customer contacted by system 1000. The aforementioned ASP webscreens 4400 can display sought after information such as dollars spent by individual customer contacted in a specific campaign and total revenues generated by a campaign in a selected timeframe. This is very valuable information when assessing the value of campaigns to the dealership. Individual and accumulative satisfaction of customers with their transactions with the dealership can be shown linked to the individual at the dealership who was the primary contact for the transaction. Another function is to map each customer's home address to give the dealership an indication of the specific areas to target with other specialized sales and marketing campaigns. The reporting possibilities are limited only by the information in the final SQL tables.

While the invention has been described in connection with what is presently considered the most practical and preferred embodiment(s), it is to be understood that the invention is not limited to the disclosed embodiment(s) but, on the contrary is intended to cover various modifications and equivalent arrangements included within the scope of the appended claims.

1. An improved client communication method, system, and computer program for sales, service, and customer satisfaction reporting comprising:
extraction means for extracting service provider data from a databank, said data including information pertaining to sales and service by client;
a plurality of communication means whereby said clients may initiate or respond to appointments for sales or service with said service providers, said service providers may communicate sales or services offers to said customers, said communication means further enabling said customers to respond to said sales or service offers.

2. The method, system and computer program of claim 1 further comprising:
tracking means whereby information relevant to said sales appointment, said service appointment or said offers may be compared with said service provider data.

3. The method, system and computer program of claim 1 further comprising:
said data including information pertaining to sales and service by client.

4. The method system and computer program of claim 1 further comprising:
said plurality of communication means including at least one from the group consisting of telephony, e-mail, U.S. mail, web-based mail, sms text messaging and website interaction.

5. The method system and computer program of claim 4 further comprising:
selection means allowing said client to prioritize preferred communication means to and from said service provider.

6. The method system and computer program of claim 1 further comprising:
reporting means for reporting results compiled by said tracking means.

7. The method system and computer program of claim 1 wherein:
said client responses include at least one from the group consisting of confirmation, acceptance, cancellation, declination and rescheduling of said appointments or said offers.

8. The method system and computer program of claim 2 wherein:
said information from said tracking means including information from the group containing: revenues from labor, parts, or sales; service provider employee or employees; customer service performance; and productivity.

9. The method system and computer program of claim 1 wherein:
said sales or service offers being selected for each client based upon said data.

10. An improved client communication method, system, and computer program product for sales, service, and customer satisfaction reporting comprising:
extraction means for extracting service provider data from a databank, said data including information pertaining to sales and service by client;
a plurality of communication means whereby said clients may initiate or respond to appointments for sales or service with said service providers, said service providers may offer sales or services to said customers, said communication means further enabling said customers to respond to said sales or service offers, said sales or service offers being selected for each client based upon said data, said plurality of communication means including at least one from the group consisting of telephony, e-mail, U.S. mail, web-based mail, sms text messaging and website interaction;
selection means allowing said client to prioritize preferred communication means to and from said service provider;
tracking means whereby information relevant to said sales appointment, service appointment or campaign is analyzed, said information from said tracking means including information from the group containing: revenues from labor, parts, or sales; service provider employee or employees; customer service performance; and productivity; and
reporting means for reporting results generated by said tracking means.
